(19) United States
(12) Patent Application Publication
(10) Pub. No.: US 2013/0085219 A1
(43) Pub. Date: Apr. 4, 2013

(54) GLOSSY HYDROPHOBIC AUTOMOTIVE COATING

(71) Applicant: Prestone Products Compnay, Lake Forest, IL (US)

(72) Inventor: Colin Dilley, Thomaston, CT (US)

(73) Assignee: PRESTONE PRODUCTS COMPANY, Lake Forest, IL (US)

(21) Appl. No.: 13/625,975

(22) Filed: Sep. 25, 2012

Related U.S. Application Data
(60) Provisional application No. 61/541,689, filed on Sep. 30, 2011.

(51) Int. Cl. C09D 183/00

(52) U.S. Cl. 524/413; 524/430; 524/588

(57) ABSTRACT

An automotive coating composition comprising nano metal oxide dispersion, a silicone carrier, a silicone resin, and a silicone crosslinker. The coating can be applied by aerosol spray.

### CROSS REFERENCE TO RELATED APPLICATIONS

This application claims the benefit of U.S. Provisional Patent Application Ser. No. 61/541,689 titled “Glossy Hydrophobic Automotive Coating” and filed Sep. 30, 2011, the contents of which are incorporated herein by reference in their entirety.

### BACKGROUND

Automotive surfaces are readily dirtied by soil insults. Soil insults can be aqueous or non-aqueous, organic or inorganic, solutions, suspensions or dry soils such as dust. Often multiple insults comprise a mixture of many different types of soil. Automotive surfaces may be treated with wax or other appearance polishes to temporarily protect an automotive surface but these surface treatments do not keep a vehicle clean. Thus there is a need for a coating which both protects an automotive surface and keeps an automotive surface clean.

Hydrophobic and super hydrophobic coating compositions for automotive surfaces present special and specific issues. It is desirable that the coating composition results in a coating having a transparent glossy finish without haze, streaking or altering the color of the surface or substrate below, i.e. to match or enhance the surface aesthetics of the automotive surface. It is also desirable for the coating composition to be useful for a range of surfaces and substrates. In some instances it is desirable for the coating composition to be useful for one type of surface or substrate, such as a painted surface, and do no harm to a second type of surface or substrate such as rubber or plastic. Additionally it is desirable that the coating composition result in a coating having a transparent glossy finish without haze, streaking or altering the color of the surface or substrate below. Furthermore, a coating durability of greater than or equal to a month is desirable and the coating should wear without discoloration, chipping, hazing or crazing. Currently, no coating composition is available that adequately meets the majority of these characteristics.

### BRIEF DESCRIPTION

Disclosed herein is an automotive coating composition comprising nano metal oxide dispersion, a silicone carrier, a silicone resin and a silicone crosslinker. The coating can be applied by aerosol spray.

The method and treatment system are described in greater detail below.

### DETAILED DESCRIPTION

Suitable nano metal oxides include silica, titanium oxide, aluminum oxide, and zinc oxide. Nano metal oxides have an average particle size of 20 nanometers (nm) to 20 micrometers. Within this range the nano metal oxides can have an average particle size less than or equal to 700 nanometers, or, more specifically, an average particle size of 20 to 450 nanometers. Additionally, the nano metal oxide has, in some embodiments, a maximum particle size of less than or equal to 450 nm, or, more specifically, less than or equal to 400 nm. Maximum particle size defines the maximum sized particle allowed.

The nano metal oxide is dispersed in a silicone resin. For example, a hydrophobically modified silica can be dispersed in a silicone fluid such as cyclomethicone. The dispersion can have a solids content of 20 to 40%. An exemplary commercially available nano metal oxide dispersion is Tegotop 210 available from Evonik Corp.

The nano metal oxide dispersion is present in an amount of 10 to 20 weight percent based on the total weight of the coating composition. Within this range the amount of nano metal oxide dispersion can be greater than or equal to 12 weight percent. Also within this range the amount of nano metal oxide dispersion can be less than or equal to 18 weight percent.

The silicone carrier is volatile and can be a low molecular weight methylsiloxane, (octamethyltrisiloxane, hexamethyldisiloxane) or a D4-D6 volatile cyclic, which has a volatility similar to ethanol or isopropanol. The silicone carrier can further comprise an organic solvent such as propylene glycol methyl ether. Exemplary silicone carriers include Dow Corning 245 silicone fluid, Dow Corning 246 silicone fluid, OS-20 and OS-120 available from Dow Corning and volatile cyclomethicone, cyclohexasiloxane and cyclopentasiloxane (D4-D6) silicones available from Dow Corning. In some embodiments the silicone carrier has dynamic viscosity less than or equal to 5, more specifically, less than or equal to 2. In some embodiments the silicone carrier has a vapor pressure of less than or equal to 50 millimeter Hg at 25° C., more specifically less than or equal to 20 mm Hg at 25° C.

The silicone carrier is present in an amount of 70 to 90 weight percent, based on the total weight of the coating composition. Within this range the silicone carrier is present in an amount greater than or equal to 75 weight percent. Also within this range the silicone carrier is present in an amount less than or equal to 85 weight percent.

The silicone resin is a type of silicone material which is formed by branched, cage-like oligosiloxanes with the general formula of RₙSiXₘO_{y}, where R is a non reactive substituent, usually Me or Ph, and X is a functional group H, OH, Cl or OR′. These groups are further condensed in many applications, to give highly crosslinked, insoluble polysiloxane networks. When R is methyl, the four possible functional siloxane monomeric units are described as follows: “M” stands for Me₃SiO, “D” for Me₂SiO₂, “T” for MeSiO₃, “Q” for SiO₄. Resins are usually a mix of the above i.e., MQ resin. Exemplary silicone resins include SS4267, a 50 centistokes dimethicone commercially available from Momentive Performance Materials.

The silicone resin is present in an amount of 1 to 5 weight percent, based on the total weight of the coating composition. Within this range the silicone carrier is present in an amount greater than or equal to 1.5 weight percent. Also within this range the silicone carrier is present in an amount less than or equal to 3 weight percent.

The silicone crosslinker forms a chemical bond between the nano metal oxide and the silicone resin, between the nano metal oxide and the substrate, between the silicone resin and the substrate or a combination of any of the foregoing. The silicone crosslinker is polyfunctional and the functionalities of the crosslinker are chosen, at least in part, based on the functionality of the nano metal oxide, substrate and silicone resin.

Useful silicone crosslinkers include fluorofunctional silicone crosslinkers and vinylpolyethoxysilanes. Exemplary silicone crosslinkers include Syl Off Q2-7560 and Syl Off SL 8 available from Dow Corning as well as Dynasylan VTEO available from Evonik Degussa Corp.

The silicone crosslinker can be present in an amount of 0.01 to 1.0 weight percent, based on the total weight of the coating composition. Within this range the amount of silicone crosslinker can be greater than or equal to 0.25 weight percent. Also within this range the amount of silicone crosslinker can be less than or equal to 0.75 weight percent. The amount of silicone crosslinker is chosen to provide adequate functional groups to form a stable and crosslinked coating with the silicone resin and nano metal oxide.

The coating composition may optionally comprise an additional silicone resin, a hydrophobicity agent or a combination of the foregoing. Additional silicone resins include SS 4267 available from Momentive Performance Materials.

The coating composition is made by blending the components in a manner sufficient to result in an essentially homogeneous composition. The silicone carrier and silicone crosslinker are combined to form a first mixture. The nano metal oxide particles are then added to the first mixture to form a second mixture. The silicone resin is then added to the second mixture to form the coating composition.

The above-described methods and compositions are further illustrated by the following non-limiting examples.

All ranges disclosed herein are inclusive and combinable. While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. An automotive coating composition comprising nano metal oxide dispersion, a silicone carrier, a silicone resin, and a silicone crosslinker.

2. The composition of claim 1, wherein the nano metal oxide is selected from the group consisting of silica, titanium oxide, aluminum oxide, and zinc oxide.

3. The composition of claim 1, wherein the nano metal oxide dispersion comprises a hydrophobically modified silica dispersed in a silicone fluid.

4. The composition of claim 1, wherein the nano metal oxide dispersion comprises nano metal oxide particles having an average particle size of 20 nanometers to 20 micrometers.

5. The composition of claim 1, wherein the nano metal oxide dispersion comprises nano metal oxide particles having an average particle size of 20 to 450 nanometers.

6. The composition of claim 1, wherein the nano metal oxide dispersion has a solids content of 20 to 40%.

7. The composition of claim 1, wherein the nano metal oxide dispersion is present in an amount of 10 to 20 weight percent based on the total weight of the coating composition.

8. The composition of claim 1, wherein the silicone carrier is present in an amount of 70 to 90 weight percent, based on the total weight of the coating composition.

9. The composition of claim 1, wherein the silicone resin is present in an amount of 1 to 5 weight percent, based on the total weight of the coating composition.

10. The composition of claim 1, wherein the silicone crosslinker is present in an amount of 0.01 to 1.0 weight percent, based on the total weight of the coating composition.
